(19) United States
(12) Patent Application Publication
(10) Pub. No.: US 2026/0167266 A1
(43) Pub. Date: Jun. 18, 2026

(54) REVERSING CONTROL APPARATUS AND METHOD FOR VEHICLES IN FLAT TOW MODE

(71) Applicants: HYUNDAI MOTOR COMPANY, SEOUL (KR); KIA CORPORATION, SEOUL (KR)

(72) Inventor: Dong Il Yang, Hwaseong-si (KR)

(73) Assignees: HYUNDAI MOTOR COMPANY, SEOUL (KR); KIA CORPORATION, SEOUL (KR)

(21) Appl. No.: 19/265,376

(22) Filed: Jul. 10, 2025

(30) Foreign Application Priority Data
Dec. 13, 2024 (KR) 10-2024-0185381

(51) Int. Cl. B62D 13/06

(52) U.S. Cl. CPC B62D 13/06

(57) ABSTRACT

A reversing control apparatus for vehicles in a flat tow mode includes at least one distance sensor installed in a towed vehicle to detect a distance from the towed vehicle to a towing vehicle, in a state in which the two vehicles are connected by a towing device, a controller mounted in the towed vehicle to output a control signal to control steering of the towed vehicle based on distance information detected by the at least one distance sensor, and a steering device configured to perform the steering of the towed vehicle depending on the control signal. The controller determines a required steering angle and a steering direction of the towed vehicle based on the distance information, when the towing vehicle and the towed vehicle are reversed, and outputs the control signal based on the determined required steering angle and steering direction.

### CROSS REFERENCE TO RELATED APPLICATIONS

This application claims under 35 U.S.C. § 119 (a) the benefit of priority from Korean Patent Application No. 10-2024-0185381 filed on Dec. 13, 2024, the entire contents of which are incorporated herein by reference.

### BACKGROUND

### (a) Technical Field

The present disclosure relates to a reversing control apparatus and method that enable stable reversing of a towing vehicle and a towed vehicle in a flat tow mode in which the towing vehicle and the towed vehicle are connected by a towing device, such as a tow bar.

### (b) Background Art

As is known, eco-friendly vehicles are vehicles that are driven by electrical driving force, and use a motor as a driving device to drive the vehicle. Eco-friendly vehicles are equipped with a motor that generates driving force, an inverter that drives and controls the motor, and an energy storage system that stores electrical energy to drive the motor, as main power components.

The inverter controls current applied to the motor, and the energy storage system is a main source of electrical energy, which may include a general high-voltage battery installed in eco-friendly vehicles.

In an eco-friendly vehicle that is driven by electrical driving force (i.e., the driving force of a motor), the battery of the energy storage system is connected to the motor via the inverter so as to be capable of being charged and discharged.

In addition, when braking or coasting in the vehicle driven by the motor, regenerative braking in which the kinetic energy of the vehicle is recovered as electrical energy using the motor as a generator may be performed. The motor is operated as a generator with the rotational force of driving wheels to generate electrical energy, and the battery is charged with the generated electrical energy.

Meanwhile, in the case of an owner having two or more vehicles, when it is necessary to use both vehicles at a desired destination, the neutral towing function may be used to take both vehicles to the desired destination.

For example, one vehicle is set as a towing vehicle that is actually driven, and the other vehicle is set as a towed vehicle connected to the rear part of the towing vehicle, and the towing vehicle and the towed vehicle are connected by a towing device, such as a tow bar, and moved together to a desired destination.

At this time, the towing vehicle generates driving force to drive the towing vehicle, the towed vehicle is set and maintained in the neutral (N) gear position, and the towing vehicle tows the towed vehicle.

The neutral towing function is a function that allows the towed vehicle to be easily towed by setting the gear position of the towed vehicle to the neutral (N) gear position so that the towed vehicle is maintained in an unloaded state.

Recently, a flat tow mode is being developed in which, when an electric vehicle (EV) capable of performing regenerative braking as a towed vehicle is connected to a towing vehicle and is then towed, EV towing charging, in which a battery is charged using regenerative braking of the electric vehicle, which is the towed vehicle, may be performed.

For example, when an electric vehicle (EV) as a sub-vehicle is connected to a camping car and towed in the flat tow mode, the battery of the electric vehicle, which is a towed vehicle, may be charged using regenerative braking of the electric vehicle.

FIG. 1 is a view illustrating an EV towing charging state in which, when a towing vehicle 100 tows an electric vehicle (EV) 200, which is a towed vehicle 200, the battery of the towed vehicle 200 is charged through regenerative braking control. Here, reference numeral “300” indicates a towing device, such as a tow bar, that connects the towing vehicle 100 and the towed vehicle 200.

In the flat tow mode, as shown in this figure, the flat tow mode is a mode in which the towing vehicle 100 tows the towed vehicle 200 while all four wheels of the towed vehicle 200 are in contact with the ground, and if the towed vehicle 200 is an electric vehicle, EV towing charging may be performed.

When EV towing charging of the towed vehicle 200 is performed, the battery is charged by regenerative braking by a motor, and thus, the motor and driving wheels of the towed vehicle 200 are connected so that power transmission is possible (the N gear position is released).

Conventionally, when towing an electric vehicle, there was a risk of damage to the power electronics (PE) parts of the electric vehicle, and therefore, if a towed vehicle is an electric vehicle, it was recommended to tow the towed vehicle in a state in which the wheels of the towed vehicle are not in contact with the ground.

When using the flat tow mode, the towing vehicle 100 and the towed vehicle 200 are connected through the towing device 300, and a user (driver) turns on the towed vehicle 200 (“EV Ready”), and then selects and activates the flat tow mode through an audio, video, and navigation system.

Thereafter, when the driver enters on the towing vehicle 100 and starts driving of the towing vehicle 100, the towed vehicle 200 starts control for the flat tow mode, and then, a battery (not shown) of the towed vehicle 200 may be charged to a predetermined target SoC through regenerative braking control of the electric vehicle, which is the towed vehicle 200, during driving of the towing vehicle 100 in which towing of the towed vehicle 200 is performed, in the flat tow mode.

However, in the flat tow mode where the towing vehicle 100 and the towed vehicle 200 are moved together while being connected, as described above, there may be cases where the vehicles 100 and 200 need to be reversed after towing (e.g., when parking, etc.) or during towing.

However, because the towing vehicle 100 and the towed vehicle 200 are connected by the tow bar (towing device) 300, when the two vehicles 100 and 200 are reversed simultaneously using the driving force of the towing vehicle 100, the force from the towing vehicle 100 is transmitted to the towed vehicle 200 through the tow bar 300, which acts as a link, and reversing of the towed vehicle 200 may become unstable.

Thus, when vehicles are reversed with the driving force of a towing vehicle, a towed vehicle is steered in an undesired direction. For example, when both the towing vehicle and the towed vehicle are to be reversed straight instead of to the left or right, the towed vehicle may be reversed while moved to the left or right even if the towing vehicle does not perform steering.

In order to move the towed vehicle backwards straight, the driver of the towing vehicle must drive while turning the steering wheel of the towing vehicle to the left or right, and there is a difficulty of having to turn the steering wheel of the towing vehicle in the opposite direction to a direction in which the towed vehicle should be reversed.

In addition, when the towing vehicle is steered while being reversed, the driving force of the towing vehicle is transmitted to the towed vehicle through a tow bar serving as a link, and thus, there is a problem in which the towed vehicle is easily steered in the opposite direction to the towing vehicle.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with prior art, and it is an object of the present disclosure to provide a reversing control apparatus and method for vehicles that may assist a towing vehicle and a towed vehicle to be reversed as desired by a driver, and eliminate driving instability of the towing vehicle and towed vehicle during reversing, through self-steering control of the towed vehicle depending on a situation when the towing vehicle and the towed vehicle are reversed while being connected.

In one aspect, the present disclosure provides a reversing control apparatus for vehicles in a flat tow mode including at least one distance sensor installed in a towed vehicle to detect a distance from a front end of the towed vehicle to a rear end of a towing vehicle, in a state in which the towed vehicle is connected to the towing vehicle by a towing device, a controller mounted in the towed vehicle to output a control signal to control steering of the towed vehicle based on distance information detected by the at least one distance sensor, and a steering device configured to perform the steering of the towed vehicle depending on the control signal from the controller, wherein the controller determines a required steering angle and a steering direction of the towed vehicle based on the distance information detected by the at least one distance sensor, when the towing vehicle and the towed vehicle are reversed, and outputs the control signal to control the steering of the towed vehicle based on the determined required steering angle and steering direction.

In an embodiment, the at least one distance sensor may include one or both of a left distance sensor installed at a left side of the front end of the towed vehicle to detect a distance from the left side of the front end of the towed vehicle to a left side of the rear end of the towing vehicle, and a right distance sensor installed at a right side of the front end of the towed vehicle to detect a distance from the right side of the front end of the towed vehicle to a right side of the rear end of the towing vehicle.

In another embodiment, the distance information may include a first distance from a left side of the front end of the towed vehicle to a left side of the rear end of the towing vehicle, and a second distance from a right side of the front end of the towed vehicle to a right side of the rear end of the towing vehicle.

In still another embodiment, the required steering angle may be a steering angle of the towed vehicle required until the first distance and the second distance become equal.

In yet another embodiment, the distance information may further include a third distance as a distance between the towing vehicle and the towed vehicle at a position where the towing vehicle and the towed vehicle are connected by the towing device.

In still yet another embodiment, the required steering angle may be a steering angle of the towed vehicle required until the first distance or the second distance becomes equal to the third distance.

In a further embodiment, the towing device may be a tow bar, and the third distance may be information preset in the controller as a length of the tow bar.

In another further embodiment, the distance information may include one of a first distance from a left side of the front end of the towed vehicle to a left side of the rear end of the towing vehicle, and a second distance from a right side of the front end of the towed vehicle to a right side of the rear end of the towing vehicle, and a third distance as a distance between the towing vehicle and the towed vehicle at a position where the towing vehicle and the towed vehicle are connected by the towing device.

In still another further embodiment, the required steering angle may be a steering angle of the towed vehicle required until the one of the first distance and the second distance becomes equal to the third distance.

In yet another further embodiment, the controller may output the control signal to control the steering of the towed vehicle, upon determining that preset steering control entry conditions are satisfied from the required steering angle, and the steering control entry conditions may include a condition in which an absolute value of the required steering angle is greater than or equal to a control entry threshold value, and a condition in which the absolute value of the required steering angle is less than a set steering angle.

In still yet another further embodiment, the reversing control apparatus may further include reversing detection sensors installed in the towed vehicle to detect reversing of the towing vehicle and the towed vehicle.

In a still further embodiment, the reversing detection sensors may include a vehicle speed sensor configured to detect a vehicle speed of the towed vehicle, and a motor speed sensor configured to detect a speed of a motor as a driving device of the towed vehicle, and the controller may determine that the towing vehicle and the towed vehicle are being reversed, if the vehicle speed detected by the vehicle speed sensor exceeds a first set value, and if the motor is determined to be rotated in a reverse direction in which the towed vehicle is moved backwards from motor speed information detected by the motor speed sensor, and an absolute value of the speed of the motor exceeds a second set value.

In another aspect, the present disclosure provides a reversing control method for vehicles in a flat tow mode including determining, by a controller mounted in a towed vehicle, whether a towing vehicle and the towed vehicle are reversed, in a state in which the towed vehicle is connected to the towing vehicle by a towing device, obtaining, by the controller, distance information from a front end of the towed vehicle to a rear end of the towing vehicle through distance sensors installed in the towed vehicle, when the towing vehicle and the towed vehicle are reversed, determining, by the controller, a required steering angle and a steering direction of the towed vehicle based on the obtained distance information, and controlling, by the controller, a steering device of the towed vehicle to perform steering of the towed vehicle based on the determined required steering angle and steering direction.

In an embodiment, the distance information may include a first distance from a left side of the front end of the towed vehicle to a left side of the rear end of the towing vehicle, and a second distance from a right side of the front end of the towed vehicle to a right side of the rear end of the towing vehicle.

In another embodiment, the required steering angle may be a steering angle of the towed vehicle required until the first distance and the second distance become equal.

In still another embodiment, the distance information may further include a third distance as a distance between the towing vehicle and the towed vehicle at a position where the towing vehicle and the towed vehicle are connected by the towing device.

In yet another embodiment, the required steering angle may be a steering angle of the towed vehicle required until the first distance or the second distance becomes equal to the third distance.

In still yet another embodiment, the distance information may include one of a first distance from a left side of the front end of the towed vehicle to a left side of the rear end of the towing vehicle, and a second distance from a right side of the front end of the towed vehicle to a right side of the rear end of the towing vehicle, and a third distance as a distance between the towing vehicle and the towed vehicle at a position where the towing vehicle and the towed vehicle are connected by the towing device.

In a further embodiment, the required steering angle may be a steering angle of the towed vehicle required until the one of the first distance and the second distance becomes equal to the third distance.

In another further embodiment, the controller may control the steering device of the towed vehicle, upon determining that preset steering control entry conditions are satisfied from the required steering angle, and the steering control entry conditions may include a condition in which an absolute value of the required steering angle is greater than or equal to a control entry threshold value, and a condition in which the absolute value of the required steering angle is less than a set steering angle.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a diagram briefly illustrating a state in which towing charging of an electric vehicle (EV) is performed when towing in a general flat tow mode;

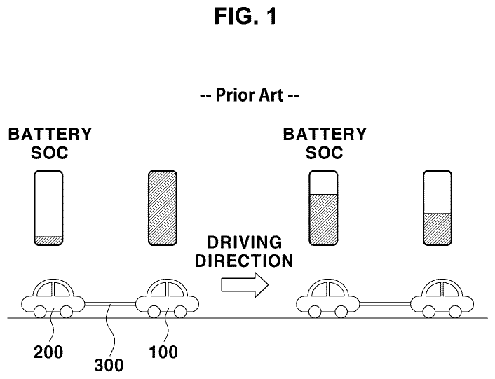

FIG. 2 is a diagram for explaining a state in which a towing vehicle and a towed vehicle are reversed according to the present disclosure;

FIG. 3 is a block diagram illustrating the configuration of a reversing control apparatus according to the present disclosure;

FIG. 4 is a flowchart illustrating a reversing control process according to the present disclosure; and

FIG. 5 is a diagram for explaining a method of calculating a required steering angle according to the present disclosure.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter embodiments of the present disclosure will be described in detail with reference to the accompanying drawings. Specific structural or functional descriptions set forth in the embodiments of the present disclosure will be merely exemplarily given to describe the embodiments depending on the concept of the present disclosure, and the embodiments depending on the concept of the present disclosure may be embodied in different forms. Further, the present disclosure should not be construed as being limited to the embodiments set forth herein, and it will be understood that the present disclosure includes all modifications, equivalents, or substitutes included in the spirit and technical scope of the disclosure.

In the following description of the embodiments, terms, such as “first,” “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” etc.

Wherever possible, the same reference numbers will be used throughout the following description to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

The present disclosure relates to a reversing control apparatus and method for vehicles in a flat tow mode, and more particularly to an apparatus and method of performing reversing stabilization control of a towing vehicle and a towed vehicle.

Specifically, the present disclosure relates to an apparatus and method of controlling a towed vehicle connected to the rear part of a towing vehicle to be stably reversed when the towing vehicle is reversed in the flat tow mode.

The reversing control apparatus and method according to the present disclosure is applied to a towed vehicle, and a vehicle subject to reversing control in the present disclosure is the towed vehicle. In addition, the subject of the reversing control in the present disclosure is a controller of the towed vehicle.

In the present disclosure, the towed vehicle is a vehicle connected to the rear part of a towing vehicle by a towing device, such as a tow bar, and may be a known electric vehicle equipped with a steering device, as a vehicle capable of being towed in the general flat tow mode.

In addition, the reversing control method according to the present disclosure may be performed in a state in which the towed vehicle is connected to the rear part of the towing vehicle by the towing device, such as a tow bar, and the flat tow mode is activated, and may be performed if the vehicles need to be reversed after vehicle towing has been performed or in the middle of vehicle towing in the flat tow mode.

In the present disclosure, when the towing vehicle and the towed vehicle are reversed in the connected state, the towed vehicle performs steering control depending on a situation, and therethrough, the towing vehicle and the towed vehicle may be reversed as desired by a driver, and driving instability of the towing vehicle and the towed vehicle during reversing is resolved.

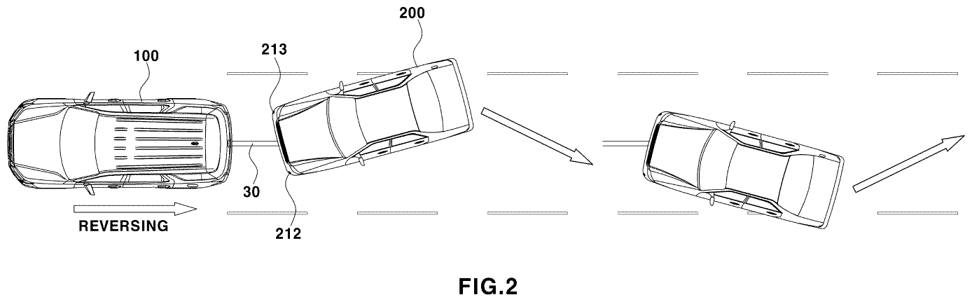

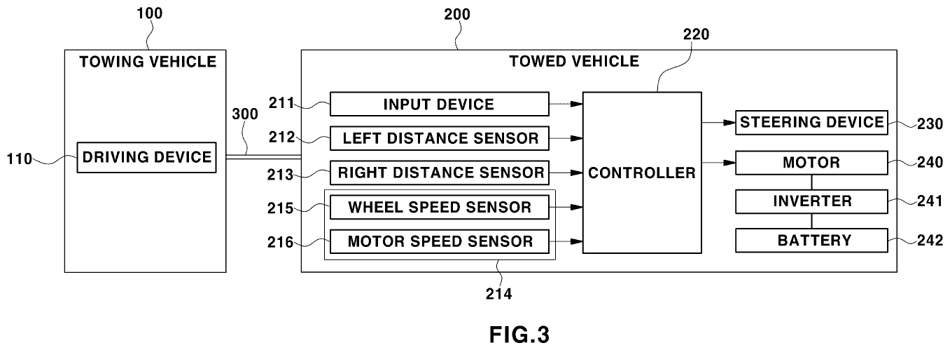

FIG. 2 is a diagram for explaining a state in which a towing vehicle and a towed vehicle are reversed by the reversing control method according to the present disclosure, and FIG. 3 is a block diagram illustrating the configuration of the reversing control apparatus according to the present disclosure. FIG. 2 illustrates a state in which distance sensors 212 and 213 are installed at the left and right sides of the front end of a towed vehicle 200, respectively.

The state of FIG. 2 may be referred to as a state in which the flat tow mode, in which a towing vehicle 100 tows the towed vehicle 200 while all four wheels of the towed vehicle 200 are in contact with the ground, is activated.

In this flat tow mode, the towing vehicle 100 and the towed vehicle 200 are connected by a towing device 300, such as a tow bar, and the two vehicles 100 and 200, i.e., the towing vehicle 100 moving at the front and the towed vehicle 200 moving at the rear, are moved by the driving force generated by a driving device 110 of the towing vehicle 100.

That is, as the driving force generated by the driving device 110 of the towing vehicle 100 is transmitted to the towed vehicle 200 through the towing device 300, the towed vehicle 200 is towed by the towing vehicle 100.

In this flat tow mode, the towed vehicle 200 that is towed from behind may be a general electric vehicle equipped with a steering device 230 (such as, for example, a steering wheel or a steering motor), and a driver may be riding in the towing vehicle 100 and driving the towing vehicle 100.

When using the flat tow mode, the towing vehicle 100 and the towed vehicle 200 are connected through the towing device 300, and a user (driver) turns on the towed vehicle 200 (“EV Ready”), and then selects and activates the flat tow mode through an input device 211 of an audio, video, and navigation (AVN) system.

Thereafter, when the driver enters the towing vehicle 100 and starts driving of the towing vehicle 100, the towed vehicle 200 that has entered the flat tow mode starts control for the flat tow mode, and EV towing charging in which a battery 242 of the towed vehicle 200 is charged through regenerative braking control of an electric vehicle, which is the towed vehicle 200, is performed during driving in the flat tow mode.

Referring to FIG. 3, the electric vehicle, which is the towed vehicle 200, is equipped with a motor 240 that generates driving force to drive the vehicle 200, an inverter 241 configured to drive and control the motor 240, and the battery 242 that stores electrical energy to drive the motor.

Hereinafter, the reversing control apparatus for vehicles according to the present disclosure will be described.

The reversing control apparatus according to the present disclosure includes the distance sensors 212 and 213 positioned at the left and right sides of the front end of the towed vehicle 200, a controller 220 mounted in the towed vehicle 200 to perform steering control of the towed vehicle 200 based on distance information detected through the left and right distance sensors 212 and 213, and the steering device 230 of the towed vehicle 200 that performs steering depending on a control signal from the controller 220.

In addition, the reversing control apparatus according to the present disclosure may further include reversing detection sensors 214 (which include wheel speed sensor 215 and motor speed sensor 216) configured to detect reversing of the towing vehicle 100 and the towed vehicle 200, and the reversing detection sensors 214 may be positioned in the towed vehicle 200.

In one embodiment of the present disclosure, the reversing detection sensors 214 may include sensors that detect driving status information of the towed vehicle 200, and the driving status information of the towed vehicle 200 may include a vehicle speed and a motor speed.

Specifically, the reversing detection sensors 214 may include a vehicle speed sensor that detects the vehicle speed of the towed vehicle 200, and a motor speed sensor installed in the motor 240 of the towed vehicle 200 that detects the motor speed (RPM) of the towed vehicle 200.

In addition the reversing control apparatus according to the present disclosure may further include the input device 211 installed in the towed vehicle 200 and provided to be operated by the driver (user) so as to select and input activation of the flat tow mode.

The distance sensors 212 and 213 may be installed at the left and right sides of the front end of the towed vehicle 200, i.e., a total of two distance sensors 212 and 213, and provided to detect a distance from each installation position to the rear end of the towing vehicle 100, which is a front object and is also a detection target.

The distance sensors 212 and 213 are electrically connected to the controller 220, and both the left distance sensor 212 and the right distance sensor 213 are provided to input an electrical signal indicating each detection value thereof to the controller 220. In one embodiment of the present disclosure, the distance sensors 212 and 213 may be ultrasonic sensors.

The vehicle speed sensor (e.g., a wheel speed sensor 215), the motor speed sensor 216, and the input device 211 are electrically connected to the controller 220, and the vehicle speed sensor and the motor speed sensor 216 are provided to input an electrical signal indicating each detection value thereof to the controller 220.

The vehicle speed sensor may be the wheel speed sensor 215 that is installed on the wheel of the towed vehicle 200 to detect the speed (rotational speed) of the wheel, and obtaining vehicle speed information from a signal from the wheel speed sensor 215 is well-known technical matter in the technical field to which the present disclosure pertains and a detailed description thereof will thus be omitted.

In one embodiment of the present disclosure, the motor speed sensor 216 is a sensor that detects the rotational speed of the motor (drive motor) 240, which is a driving device that drives the vehicle, and may be a general resolver that detects the rotor position of the motor 240.

In addition, the input device 211 is also provided to input an electrical signal depending on the operating state thereof to the controller 220 if the driver operates the input device 211 to select or input activation of the flat tow mode. The input device 211 may be the input device 211 of the AVN system, or a touchscreen of the AVN system that performs the integrated functions of an input device and a display device.

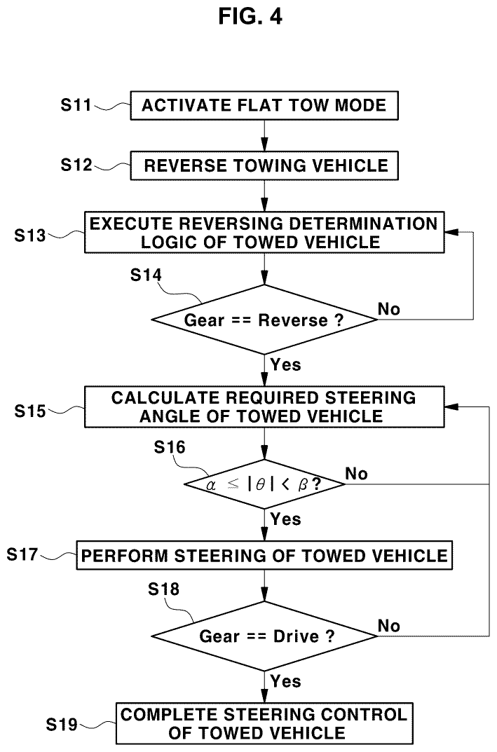

FIG. 4 is a flowchart illustrating the reversing control process according to the present disclosure. First, in the state in which the towing vehicle 100 and the towed vehicle 200 are connected by the towing device 300, such as a tow bar, the controller 220 of the towed vehicle 200 determines whether the driver selects and inputs activation of the flat tow mode (S11).

The driver may select and input the activation of the flat tow mode through the input device 211, and the controller 220 may recognize the activation of the flat tow mode, if an operation signal depending on selection and input of the activation of the flat tow mode by the driver is input from the input device 211.

As such, if the driver selects and inputs the activation of the flat tow mode, the controller 220 of the towed vehicle 200 recognizes the activation of the flat tow mode and enters the flat tow mode, and then the flat tow mode may be performed.

Thereafter, while the driver is driving the towing vehicle 100, the driver may drive the towing vehicle 100 backwards (S12), and the controller 220 of the towed vehicle 200 determines whether the towing vehicle 100 is being driven backwards depending on reversing determination logic based on driving status information of the towed vehicle 200 detected by the reversing detection sensors 214 (S13 and S14).

When the reversing determination logic is executed, the controller 220 determines whether the towed vehicle 200 is being moved backwards together with the towing vehicle 100 based on signals from the reversing detection sensor 214 installed in the towed vehicle 200. At this time, the controller 220 may determine whether the towing vehicle 100 is reversed from the vehicle speed of the towed vehicle 200 detected by the vehicle speed sensor (e.g., the wheel speed sensor 215) and the motor speed of the towed vehicle 200 detected by the motor speed sensor 216.

That is, the reversing determination logic in the controller 220 may be set and configured to determine whether the towing vehicle 100 is reversed using the driving status information of the towed vehicle 200 as input, specifically, the vehicle speed and motor speed of the towed vehicle 200 as input.

Because the towing vehicle 100 and the towed vehicle 200 are connected by the towing device 300, when the towing vehicle 100 is reversed, the towed vehicle 200 is also pushed and reversed, and accordingly, in the reversing determination logic, upon determining that the towed vehicle 200 is reversed using the detection value from the reversing detection sensors 214 installed in the towed vehicle 200, the towing vehicle 100 may be determined to be reversed.

To explain in more detail a method of determining whether the towing vehicle 100 is reversed, in the reversing determination logic, if the vehicle speed detected by the vehicle speed sensor (e.g., the wheel speed sensor 215) of the towed vehicle 200 exceeds a first set value (e.g., 1 km/hr), the motor 240 is determined to be rotated in the reverse direction from the motor speed detected by the motor speed sensor 216, and the absolute value of the motor speed exceeds a second et value (for example, 50 rpm), the controller 220 may determine that the towing vehicle 100 is reversed together with the towed vehicle 200.

If the towed vehicle 200 is reversed by the towing vehicle 100, the motor 240, which is the driving device that drives the vehicle, is rotated by receiving the rotational force of the wheels (driving wheels connected to the motor 240 so as to transmit power) of the towed vehicle 200.

In addition, if the towed vehicle 200 is reversed by the towing vehicle 100, the wheels are rotated in the opposite direction to the driving direction, the motor 240 is also rotated in the opposite direction to the driving direction, and at this time, the motor speed may be defined as a negative (−) value.

In this way, if the motor speed of the towed vehicle 200 during reversing is defined as a negative (−) value, the absolute value of the motor speed that exceeds the second set value set as the above positive (+) value means that the motor speed of the towed vehicle 200, which is the negative (−) value, is less than “− second set value”, and means that the motor 240 of the towed vehicle 200 is rotated at a speed greater than or equal to a designated level in the reverse direction (the rotating direction of the motor 240 when the towed vehicle 200 is driven forwards is a forward direction).

When the towed vehicle 200 is reversed, the wheels of the towed vehicle 200 are rotated at a speed greater than or equal to the designated level in the reverse direction, which is a direction in which the towed vehicle 200 is driven backwards, and at this time, the motor 240 is rotated in the reverse direction by the reverse rotational force transmitted from the wheels. Therefore, the fact that the motor 240 of the towed vehicle 200 is rotated in the reverse direction at a speed greater than or equal to the designated level means that the towed vehicle 200 is actually being reversed as the motor 240 and the wheels are rotated in the reverse direction.

As described above, upon determining that the towed vehicle 200 is being reversed (“Gear==Reverse”), the controller 220 calculates a required steering angle θ of the towed vehicle 200 (S15). At this time, the distance information detected by the left distance sensor 212 and the right distance sensor 213 installed in the towed vehicle 200 are used, and a process and method of calculating the required steering angle θ will be described in more detail later.

After the required steering angle θ has been determined, the controller 220 determines whether a current required steering angle state satisfies preset steering control entry conditions of the towed vehicle 200 based on the current required steering angle information (S16).

The steering control entry conditions are preset in the controller 220, and in one embodiment of the present disclosure, the steering control entry conditions include a condition in which the absolute value |θ| of the required steering angle θ is greater than or equal to a control entry threshold value α, and a condition in which the absolute value |θ| of the required steering angle θ is less than a set steering angle β.

In one embodiment of the present disclosure, the controller 220 may be set to determine that the current required steering angle state satisfies the steering control entry conditions when both conditions are satisfied.

The control entry threshold value a is defined as the minimum steering angle required to enter steering control, and is preset to a value greater than 0 in the controller 220 (α>0). The set steering angle β is a steering angle set in consideration of durability of the towing device 300, and is also preset to a value greater than 0 in the controller 220.

Accordingly, the controller 220 may determine that the steering control entry conditions are satisfied, if the absolute value |θ| of the required steering angle θ is greater than or equal to the control entry threshold value a and less than the set steering angle β (α≤|θ|<β), and then perform steering control of the towed vehicle 200 (S17).

In one embodiment of the present disclosure, the steering control of the towed vehicle 200 is performed only if the absolute value |θ| of the required steering angle θ is less than the set steering angle β, taking into account durability of the tow bar, which is the towing device 300 that connects the towing vehicle 100 and the towed vehicle 200.

In the present disclosure, upon determining that the steering control entry conditions of the towed vehicle 200 are satisfied from the required steering angle θ, the controller 220 performs the steering control of the towed vehicle 200. During reversing, the steering of the towed vehicle 200 may be performed by the controller 220 of the towed vehicle 200 controlling the steering device 230 of the towed vehicle 200, and at this time, the controller 220 controls the steering device 230 of the towed vehicle 200 so that the towed vehicle 200 is steered by the required steering angle θ.

Thereafter, if the towed vehicle 200 is switched from the reversing state to the forward driving state (“Gear==Drive”), the controller 220 terminates the steering control of the towed vehicle 200 (S18 and S19).

Hereinafter, a method of calculating the required steering angle θ and a method of performing the steering control of the towed vehicle 200 depending on the required steering angle θ will be described in detail.

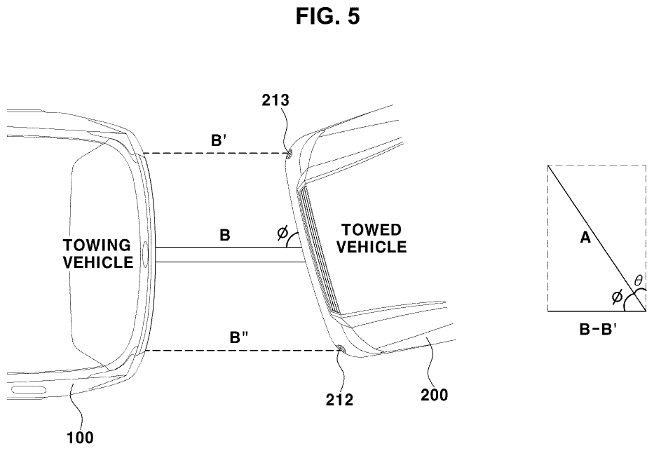

FIG. 5 is a diagram for explaining the method of calculating the required steering angle according to the present disclosure, and as illustrated, the left distance sensor 212 and the right distance sensor 213 installed at the left and right sides of the front end of the towed vehicle 200 are used to detect distances B″ and B′ from the rear end of the towing vehicle 100 in real time, respectively.

The left distance sensor 212 and the right distance sensor 213 detect distances from the respective installation positions to the rear end of the towing vehicle 100, the left distance sensor 212 detects the distance from the left side of the front end of the towed vehicle 200 to the left side of the rear end of the towing vehicle 100, and the right distance sensor 213 detects the distance from the right side of the front end of the towed vehicle 200 to the right side of the rear end of the towing vehicle 100.

In the following description, the distance detected by the right distance sensor 213 is referred to as B′, and the distance detected by the left distance sensor 212 is referred to as B″.

In addition, a distance between the vehicles 100 and 200 at a position where the two vehicles 100 and 200 are connected by the towing device 300, i.e., the position of the tow bar, is defined as B, and the distance B may be preset in the controller 220 as the length of the tow bar (i.e., the towing device 300) between the two vehicles 100 and 200.

On the assumption that the value of ½ of the full width of the towed vehicle 200 is A, the required steering angle θ may be calculated as in Mathematical expression 1 below.

Mathematical expression 1:

$$θ = 90 ° - {cos}^{- 1} ( \frac{B - {B}^{′}}{A} )$$

In the present disclosure, the controller 220 may determine a direction in which the towed vehicle 200 is turned with respect to the towing vehicle 100 based on the distance B″ detected by the left distance sensor 212 and the distance B′ detected by the right distance sensor 213.

In addition, the controller 220 may determine a steering direction of the towed vehicle 200 required when reversing from distance information, i.e., the distances B, B′, and B″, and may determine the steering direction of the towed vehicle 200 required when reversing from at least the distances B and B′, or the distances B and B″.

FIG. 5 shows an example in which the distance B′ detected by the right distance sensor 213 is smaller than the distance B″ detected by the left distance sensor 212 and the distance B between the vehicles 100 and 200 at the position of the tow bar 300.

In this case, the steering wheel of the towed vehicle 200 must be turned in the clockwise direction (to the right), and at this time, the steering wheel must be turned in the clockwise direction by the required steering angle θ.

On the other hand, although not illustrated in the drawings, if the distance B″ detected by the left distance sensor 212 is smaller than the distance B′ detected by the right distance sensor 213 and the distance B between the vehicles 100 and 200 at the position of the tow bar 300, the steering wheel of the towed vehicle 200 must be turned in the counterclockwise direction (to the left) by the required steering angle θ.

In addition, Mathematical expression 1 is an expression by which the required steering angle θ may be calculated in the state in which the towed vehicle is turned to the left (steering of the steering wheel to the right, i.e., in the clockwise direction, is required), as shown in FIG. 5.

In Mathematical expression 1, B′ may be replaced with B″, or B-B′ may be replaced with B-B″ depending on the direction in which the towed vehicle 200 is turned with respect to the towing vehicle 100. That is, if the towed vehicle 200 is turned in the opposite direction to FIG. 5 with respect to the towing vehicle 100, i.e., if the towed vehicle is turned to the right (steering of the steering wheel to the left, i.e., in the counterclockwise direction, is required), in Mathematical expression 1, B″ may be used instead of B′, or B-B″ may be use instead of B-B′.

In the present disclosure, steering in the clockwise direction or in the counterclockwise direction by the required steering angle θ may be performed by the controller 220 controlling the steering device 230 of the towed vehicle 200 so that the steering device 230 performs steering in the corresponding direction by the required steering angle θ. At this time, the controller 220 may control the steering device 230 using the value of the required steering angle θ calculated in real time as a feedback value until the value of the required steering angle θ becomes a target value, i.e., 0.

Alternatively, the controller 220 may control the steering device 230 until the distance B″ detected by the left distance sensor 212 becomes equal to the distance B′ detected by the right distance sensor 213 or the respective distances B′ and B″ becomes equal to the distance B between the vehicles 100 and 200 at the position of the tow bar 300.

Although an embodiment using both the left distance sensor 212 and the right distance sensor 213 as distance sensors has been described above, if the controller 220 knows the distance B between the vehicles 100 and 200 at the tow bar position, only one of the left distance sensor 212 and the right distance sensor 213 may be used.

That is, the distance sensors in the present disclosure include one or both of the left distance sensor 212 and the right distance sensor 213, and one or both of the left distance sensor 212 and the right distance sensor 213 may be used.

At this time, the required steering angle θ and the steering direction of the towed vehicle 200 during reversing may be determined in the same manner using the value of the distance B′ or B′ detected by the distance sensor, the value of the distance, which is distance information set in the controller 220, and the value of A, which is ½ of the full width of the towed vehicle 200 set in the controller 220.

In addition, in the present disclosure, if the distance B″ detected by the left distance sensor 212 is referred to a first distance, the distance B′ detected by the right distance sensor 213 is referred to as a second distance, and the distance B between the vehicles 100 and 200 at the tow bar position is referred to as a third distance, the required steering angle θ may be the steering angle of the towed vehicle 200 until the first distance and the second distance become equal.

Alternately, the required steering angle θ may be the steering angle of the towed vehicle 200 required when steering is performed so that the first distance or the second distance becomes equal to the third distance.

In the present disclosure, the required steering angle θ may be determined in real time and used as feedback information during the steering control of the towed vehicle 200, and for example, the steering control of the towed vehicle 200 may be performed until the required steering angle θ determined in real time becomes 0.

As is apparent from the above description, a reversing control apparatus and method for vehicles in a flat tow mode according to the present disclosure allow a towing vehicle and a towed vehicle to be reversed as desired by a driver, and eliminates driving instability of the towing vehicle and the towed vehicle during reversing, through self-steering control of the towed vehicle depending on a situation when the towing vehicle and the towed vehicle are reversed while being connected.

Although the present disclosure has been described in detail with reference to exemplary embodiments thereof, the scope of the present disclosure is not limited to the above-described embodiments, and it will be appreciated by those skilled in the art that various modifications and improvements are still within the scope of the disclosure that is defined in the appended claims and their equivalents.

1. A reversing control apparatus for vehicles in a flat tow mode comprising:
at least one distance sensor positioned in a towed vehicle and configured to detect a distance from a front end of the towed vehicle to a rear end of a towing vehicle, in a state in which the towed vehicle is connected to the towing vehicle by a towing device;
a controller mounted in the towed vehicle and configured to output a control signal to control steering of the towed vehicle based on distance information detected by the at least one distance sensor; and
a steering device configured to perform steering of the towed vehicle based on the control signal from the controller;
wherein the controller is further configured to:
determine a required steering angle and a steering direction of the towed vehicle based on the distance information detected by the at least one distance sensor, when the towing vehicle and the towed vehicle are reversed; and
output the control signal to control the steering of the towed vehicle based on the required steering angle and steering direction.

2. The reversing control apparatus of claim 1, wherein the at least one distance sensor comprises at least one of:
a left distance sensor positioned at a left side of the front end of the towed vehicle, and configured to detect a distance from the left side of the front end of the towed vehicle to a left side of the rear end of the towing vehicle; and
a right distance sensor positioned at a right side of the front end of the towed vehicle, and configured to detect a distance from the right side of the front end of the towed vehicle to a right side of the rear end of the towing vehicle.

3. The reversing control apparatus of claim 1, wherein the distance information comprises:
a first distance from a left side of the front end of the towed vehicle to a left side of the rear end of the towing vehicle; and
a second distance from a right side of the front end of the towed vehicle to a right side of the rear end of the towing vehicle.

4. The reversing control apparatus of claim 3, wherein the required steering angle is a steering angle of the towed vehicle where the first distance and the second distance are equal.

5. The reversing control apparatus of claim 3, wherein the distance information further comprises a third distance comprising a distance between the towing vehicle and the towed vehicle at a position where the towing vehicle and the towed vehicle are connected by the towing device.

6. The reversing control apparatus of claim 5, wherein the required steering angle is a steering angle of the towed vehicle where the first distance or the second distance is equal to the third distance.

7. The reversing control apparatus of claim 5, wherein:
the towing device is a tow bar; and
the third distance is information preset in the controller as a length of the tow bar.

8. The reversing control apparatus of claim 1, wherein the distance information comprises:
either a first distance from a left side of the front end of the towed vehicle to a left side of the rear end of the towing vehicle, or a second distance from a right side of the front end of the towed vehicle to a right side of the rear end of the towing vehicle; and
a third distance comprising a distance between the towing vehicle and the towed vehicle at a position where the towing vehicle and the towed vehicle are connected by the towing device.

9. The reversing control apparatus of claim 8, wherein the required steering angle is a steering angle of the towed vehicle where either the first distance or the second distance is equal to the third distance.

10. The reversing control apparatus of claim 1, wherein the controller is configured to output the control signal to control the steering of the towed vehicle, upon determining that preset steering control entry conditions are satisfied from the required steering angle; and
wherein the preset steering control entry conditions comprise a condition in which an absolute value of the required steering angle is greater than or equal to a control entry threshold value, and a condition in which the absolute value of the required steering angle is less than a set steering angle.

11. The reversing control apparatus of claim 1, further comprising a plurality of reversing detection sensors positioned in the towed vehicle and configured to detect reversing of the towing vehicle and the towed vehicle.

12. The reversing control apparatus of claim 11, wherein the plurality of reversing detection sensors comprise a vehicle speed sensor configured to detect a vehicle speed of the towed vehicle, and a motor speed sensor configured to detect a speed of a motor as a driving device of the towed vehicle;
wherein the controller is configured to determine that the towing vehicle and the towed vehicle are being reversed:
when the vehicle speed detected by the vehicle speed sensor exceeds a first set value; and
when the motor is determined to be rotated in a reverse direction in which the towed vehicle is moved backwards from motor speed information detected by the motor speed sensor, and an absolute value of the speed of the motor exceeds a second set value.

13. A reversing control method for vehicles in a flat tow mode comprising:
determining, by a controller mounted in a towed vehicle, whether a towing vehicle and the towed vehicle are reversed, in a state in which the towed vehicle is connected to the towing vehicle by a towing device;
obtaining, by the controller, distance information from a front end of the towed vehicle to a rear end of the towing vehicle from distance sensors positioned in the towed vehicle, when the towing vehicle and the towed vehicle are reversed;
determining, by the controller, a required steering angle and a steering direction of the towed vehicle based on the distance information; and
controlling, by the controller, a steering device of the towed vehicle to perform steering of the towed vehicle based on the required steering angle and steering direction.

14. The reversing control method of claim 13, wherein the distance information comprises:
a first distance from a left side of the front end of the towed vehicle to a left side of the rear end of the towing vehicle; and
a second distance from a right side of the front end of the towed vehicle to a right side of the rear end of the towing vehicle.

15. The reversing control method of claim 14, wherein the required steering angle is a steering angle of the towed vehicle where the first distance and the second distance are equal.

16. The reversing control method of claim 14, wherein the distance information further comprises a third distance comprising a distance between the towing vehicle and the towed vehicle at a position where the towing vehicle and the towed vehicle are connected by the towing device.

17. The reversing control method of claim 16, wherein the required steering angle is a steering angle of the towed vehicle where the first distance or the second distance is equal to the third distance.

18. The reversing control method of claim 13, wherein the distance information comprises:
either a first distance from a left side of the front end of the towed vehicle to a left side of the rear end of the towing vehicle, or a second distance from a right side of the front end of the towed vehicle to a right side of the rear end of the towing vehicle; and
a third distance comprising a distance between the towing vehicle and the towed vehicle at a position where the towing vehicle and the towed vehicle are connected by the towing device.

19. The reversing control method of claim 18, wherein the required steering angle is a steering angle of the towed vehicle where either the first distance or the second distance is equal to the third distance.

20. The reversing control method of claim 13, wherein the controller controls the steering device of the towed vehicle, upon determining that preset steering control entry conditions are satisfied from the required steering angle, and
wherein the preset steering control entry conditions comprise a condition in which an absolute value of the required steering angle is greater than or equal to a control entry threshold value, and a condition in which the absolute value of the required steering angle is less than a set steering angle.
